(19) United States
(12) Patent Application Publication
(10) Pub. No.: US 2010/0165156 A1
(43) Pub. Date: Jul. 1, 2010

(54) IMAGE CAPTURE DEVICE COMPRISING FOCUSING ADJUSTMENT MEANS

(75) Inventor: Hervé Mingam, Crolles (FR)

Correspondence Address: STMicroelectronics Inc.;c/o WOLF, GREENFIELD & SACKS, P.C., 600 Atlantic Avenue, BOSTON, MA, 02210-2206, US

(73) Assignee: STMicroelectronics S.A., Montrouge (FR)

(21) Appl. No.: 12/648,174

(22) Filed: Dec. 28, 2009

(30) Foreign Application Priority Data
Dec. 31, 2008 (FR) 08/59157

(51) Int. Cl. H04N 5/225

(52) U.S. Cl. 348/262; 348/E05.024

(57) ABSTRACT

An image capture device includes first and second image sensors arranged to capture first and second images respectively of a same scene, each of the first and second images including pixel values; an objective lens associated with each of the image sensors, one objective lens being axially offset with respect to the other and having the same focal length as the other; a unit for analyzing the sharpness of each image; and a unit for selecting the image of desired sharpness.

### CROSS REFERENCE TO RELATED APPLICATIONS

This application claims the priority benefit of French patent application number 08/59157, filed on Dec. 31, 2008, entitled “IMAGE CAPTURE DEVICE COMPRISING FOCUSING ADJUSTMENT MEANS,” which is hereby incorporated by reference to the maximum extent allowable by law.

### BACKGROUND OF THE INVENTION

1. Field of the Invention

The present invention relates to a device for compensating for poor focusing of images captured by several image sensors.

2. Discussion of the Related Art

Image sensors in digital image capture devices are generally formed with a charge coupled device CCD or with CMOS devices, comprising an array of pixel cells, each pixel cell comprising a photodiode for collecting electric charges and generating an output voltage according to the light that it receives.

FIG. 1A illustrates a portion of a color filter 100 for an image sensor known as a Bayer filter. A Bayer filter 100 comprises a rectangular array of elementary color filters aligned with the image sensor pixels. The color filters have the function of selecting a wavelength range of the incident light and are arranged in a pattern selected so that a square group of four color filters comprises two green filters arranged diagonally, one red filter, and one blue filter.

FIG. 1B shows an optical system comprising Bayer filter 100 of FIG. 1A, arranged on an image sensor 102 comprising a pixel cell array, each pixel cell comprising a photodiode. An image is formed on image sensor 102 by an objective lens 104. A microlens 106 is formed above each pixel cell in the array, to focus the light on an active area of the corresponding photodiode, which only takes up a determined portion of the sensor surface.

A disadvantage of Bayer filters 100 and of the similar filters is that they need to be accurately aligned on the active portion of the pixel arranged on underlying image sensor 102. Otherwise, the useful areas of these pixels might only receive a small part of the photons supposed to reach them, or even worse, the image sensor pixels intended to capture a color might receive a different color filtered by a neighboring color filter.

Another disadvantage of Bayer filters 100 and of similar filters is that forming color filters is a complex task, in particular when the pixels are very small. It is further necessary for the coloring of the filters to be able to withstand the end-of-process temperatures while keeping their “good” filtering features.

### SUMMARY OF THE INVENTION

An object of embodiments of the present invention is to provide a device which overcomes one or several disadvantages of prior art devices and which enables an image-focusing adjustment.

According to an embodiment of the present invention, an image capture device comprises first and second image sensors arranged to capture first and second images respectively of a same scene, each of the first and second images comprising pixel values; an objective lens associated with each of the image sensors, one objective lens forming an image axially offset with respect to the other; means for analyzing the sharpness of each of the images; and means for selecting the image of desired sharpness.

According to an embodiment of the present invention, one of the objective lenses is axially offset with respect to the other and has the same focal length as the other.

According to an embodiment of the present invention, the image capture device is capable of capturing color images and the first and second image sensors are associated with first and second filters of a first color, the device further comprising a third image sensor associated with a third filter of a second color and a fourth image sensor associated with a fourth filter of a third color, all image sensors being arranged to capture an image of the same scene, an objective lens being associated with each of the image sensors; and means for restoring a color image from pixels of the image selected by the selection means and from pixels corresponding to the images of the third and fourth image sensors.

According to an embodiment of the present invention, the first color is green and the second and third colors are blue and red.

The foregoing objects, features, and advantages of the present invention will be discussed in detail in the following non-limiting description of specific embodiments in connection with the accompanying drawings.

### BRIEF DESCRIPTION OF THE DRAWINGS

FIG. 1A, previously described, is a top view of a Bayer filter;

FIG. 1B schematically shows an optical system comprising the Bayer filter of FIG. 1A;

FIG. 2 is a top view of an image sensor according to an embodiment of the present invention;

FIGS. 3A and 3B schematically show an optical system according to an embodiment of the present invention; and

FIG. 4 illustrates an image capture circuit according to an embodiment of the present invention.

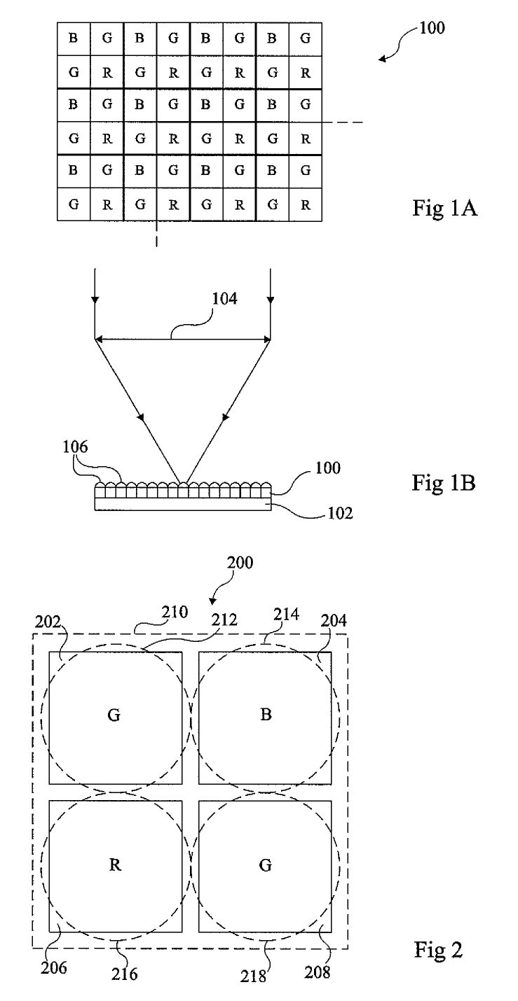

### DETAILED DESCRIPTION

FIG. 2 is a top view of an arrangement 200 of four rectangular image sensors 202, 204, 206, and 208 arranged to capture green, blue, red, and green, respectively. Each image sensor comprises an array of pixel cells. A general color filter (not shown) is associated with each image sensor 202 to 208, each general color filter being of a single color and filtering the light of an entire image sensor. The images captured by sensors 202 to 208 may be combined to provide a color image.

An arrangement of front lenses, for example, molded 210, illustrated by dotted lines in FIG. 2A, is installed above image sensors 202 to 206 to focus the image on each sensor. The front lens arrangement comprises objective lenses 212, 214, 216, and 218 arranged above sensors 202 to 208, respectively.

Images of a same scene are formed by objective lenses 212 to 218 on image sensors 202 to 208. The separation between the images sensors causes a very small difference due to the parallax error between the images formed on each sensor, but given that, in this example, the sensor centers are separated by 1 mm only, the difference can be considered as negligible.

Each of objective lenses 212 to 218 can be optimized for a specific color that it is in charge of transmitting, to avoid any chromatic aberration problem. This is an advantage over systems in which an objective lens needs to transmit all colors and thus needs to have a high chromatic quality. It is thus possible to obtain fine resolutions with molded lenses colored in the mass.

Generally, to form image sensors, active devices are formed in a semiconductor substrate, after which an interconnect stack is formed on the semiconductor substrate. The light arriving on the photodiodes arrives on the side of the interconnect stacking and needs to cross a succession of insulating layers of this stack, while the positions of the metal portions of the stack needs to be selected to avoid hindering the light propagation. This is the reason why the microlenses needs to have a high performance, and in particular, be perfectly aligned with respect to the underlying pixels, since they guide the light through the shadings caused by the interconnects. Accordingly, back side illumination devices (BSI) have been provided, in which the device is flipped and etched so that light reaches the photodiodes from the rear surface of the semiconductor substrate, that is, on the side opposite to the side on which the interconnect stack is formed. In such BSI devices, it is generally not necessary to associate a microlens with each pixel.

Although the association of the color separation according to the above principle and of the BSI technology has real advantages, the present invention also applies to conventional front-side illumination embodiments of arrays 202-208.

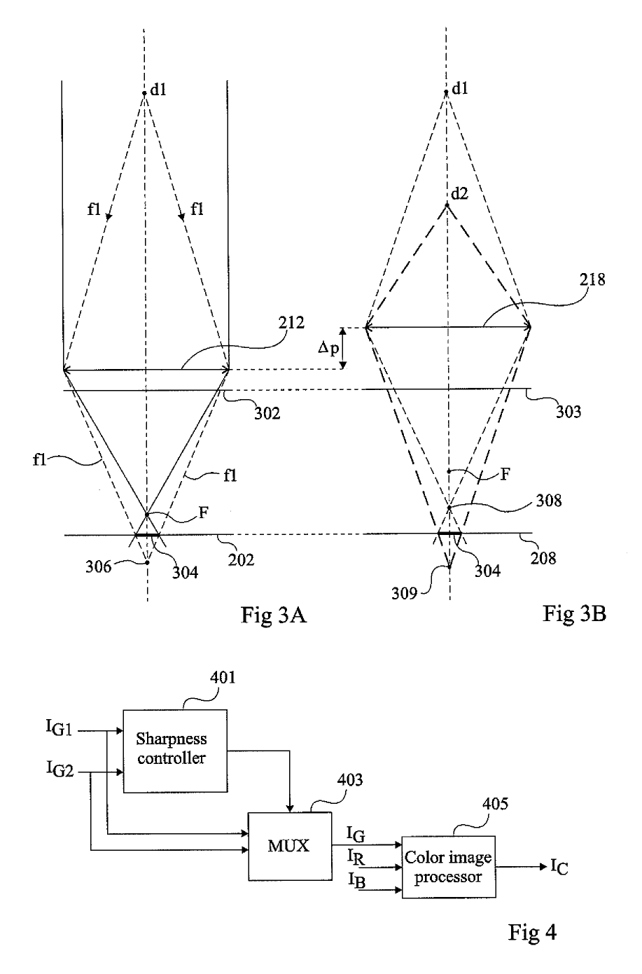

FIG. 3A schematically illustrates in cross-section view the portion of the optical system comprising first “green” image sensor 202 and objective lens 212 of FIG. 2.

Objective lens 212 forms an image on image sensor 202 (shown by a simple line), and comprises one or several lenses that may for example be molded. A general green filter 302 is arranged between objective lens 212 and image sensor 202.

As shown, an image at infinity focuses in focal plane F of objective lens 212. The sensitive area of image sensor 202 is placed at the back of focal plane F, so that a pixel 304 has lateral dimensions which substantially correspond to the image of a point at infinity in the plane of image sensor 202. The objective lens will then provide a sharp image for a scene located between the infinite and a distance d1 from objective lens 212. Distance d1 is selected so that beam f1 originating from the point at distance d1 focuses at a point 306 arranged as shown in the drawing, so that the beam going from lens 212 to point 306 has, at the level of plane 202, the extension of pixel 304. The system is then said to be of hyperfocal type, that is, there is a sharp image between infinity and distance d1.

Generally, the image sensors of the type described herein are used in very simple systems, such as cell phones which have no variable-focus objective lens.

To increase the depth of focus, it is provided, as illustrated in FIG. 3B, to associate with the second “green” image sensor 208 an objective lens 218 shifted by an offset Δp on the object side with respect to objective lens 212 and thus more remote from the plane of the associated pixel array 208. Objective lens 218 has the same focal distance as objective lens 212 and is associated with a green filter 303. Offset Δp is selected so that the image of a point at distance d1 from objective lens 212 forms at a point 308 approximately at the same distance from lens 218 as focal point F of objective lens 212. An image of a point which does not exceed the surface area of pixel 304 can thus be obtained, on the one hand, for image 308 of a point at a distance d1 from objective lens 212 (d1−Δp of objective lens 218), and on the other hand, for image 309 of a point at a distance d2 from objective lens 212 which is smaller than d1 (d2−Δp from objective lens 218).

Thus, objective lens 218 is capable of providing sharp images for points placed between distances d1 and d2, closer to the shooting device than for a conventional objective lens set between the infinite and a distance d1.

Offset Δp of objective lens 218 with respect to objective lens 212 of the first sensor can be obtained in many ways, such as, for example, by inserting a parallel plate, depositing a transparent layer forming a pedestal, etc.

The red and blue image sensors will for example be associated with objective lenses positioned in the same way as objective lens 212 and identical thereto.

According to an embodiment of the present invention, before combining the red, green, and blue images, it is provided to determine the sharpness of the green images provided by the sensors 202 and 208 associated with objective lenses 212 and 218, and to select that of these images which is the sharpest.

As illustrated in FIG. 4, signals I_{G1} and I_{G2} of the green pixels of sensors 202 and 208 may be applied to a sharpness controller 401 which determines that of the green images which is the sharpest. The output of the sharpness controller is applied to a multiplexer 430 which selects the signals I_{G} corresponding to I_{G1} and I_{G2}. These signals are used in a color image processor 405 to provide most of the brightness component of the image while the signals I_{R} and I_{B} associated with the red and blue sensors are used, with signal I_{G}, essentially for the color recovery.

Such devices for determining the sharpness and combining monochrome images to provide a color image are known by those skilled in the art and will not be described in detail herein.

The image capture device is, for example, a cell phone, a digital camera, a portable game console, or another device comprising a digital device.

Although specific embodiments have been described, it should be clear for those skilled in the art that various alterations and modifications may be used. In particular, the case where two green filters are used has been described, since this is the most conventional configuration. However, it could be chosen to determine the sharpness of any two images. For example, a system with only three red, green, and blue image sensors may also be selected, and objective lenses of different focal length may be arranged above two of these sensors, to determine the sharpest image and use this image as a basis for the determination of the brightness of the final image. Similarly, although a system in which a lens is offset with respect to the others has been described, it could be provided for one of the lenses to be more convergent that the others.

It should be clear for those skilled in the art that the various features described hereabove in relation with the different embodiments and with the state of the art may be combined in any combination.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. An image capture device comprising:
first and second image sensors arranged to capture first and second images respectively of a same scene, each of the first and second images comprising pixel values;
an objective lens associated with each of the image sensors, one objective lens forming an image axially offset with respect to the other;
means for analyzing the sharpness of each of the images; and
means for selecting the image of desired sharpness.

2. The image capture device of claim 1, wherein one of the objective lenses is axially offset with respect to the other and has the same focal length as the other.

3. The image capture device of claim 1, capable of capturing color images, wherein the first and second image sensors are associated with first and second filters of a first color, further comprising:
a third image sensor associated with a third filter of a second color and a fourth image sensor associated with a fourth filter of a third color, all image sensors being arranged to capture an image of the same scene, an objective lens being associated with each of the image sensors; and
means for restoring a color image from pixels of the image selected by the selection means and from pixels corresponding to the images of the third and fourth image sensors.

4. The image capture device of claim 3, wherein the first color is green and the second and third colors are blue and red.
